(19) United States
(12) Patent Application Publication
(10) Pub. No.: US 2007/0140722 A1
(43) Pub. Date: Jun. 21, 2007

(54) IMAGE FORMING APPARATUS AND IMAGE FORMING METHOD

(75) Inventors: Yasukazu Kobayashi, Shinagawa-ku, Tokyo (JP); Fumiyoshi Kittaka, Shinagawa-ku, Tokyo (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/561,478

(22) Filed: Nov. 20, 2006

(30) Foreign Application Priority Data
Nov. 22, 2005 (JP) 2005-337351

(51) Int. Cl. G03G 15/00

(52) U.S. Cl. 399/81; 399/82

(57) ABSTRACT

There is disclosed an image forming method for use in an image forming apparatus which includes an image forming unit that generates image data from a manuscript and forms an image, an input unit that inputs a command for operating the image forming apparatus, and a control unit that controls the image forming apparatus by exchanging information with the input unit or an external device, the method includes establishing a communication connection state for controlling the image forming apparatus by means of an operating command from the external device, invalidating the control of the image forming apparatus by the operating command from the external device in response to the cancel request from the input unit, and then, switching a current state to a state for controlling the image forming apparatus by means of the operating command from the input unit, and forcibly terminating a job being executed.

### CROSS-REFERENCE TO RELATED APPLICATIONS

This application is based upon and claims the benefit of priority from prior Japanese Patent Application No. 2005-337351, filed Nov. 22, 2005, the entire contents of which are incorporated herein by reference.

### BACKGROUND OF THE INVENTION

1. Field of the Invention

The present invention relates to an image forming apparatus and an image forming method of a multi function peripheral (hereinafter, referred to as MFP) or the like to which an external device such as a personal computer is to be connected.

2. Description of the Related Art

Conventionally, there has been proposed a MFP comprising functions such as a copy, a facsimile, a printer, and a scanner, and configured to be connectable to a network (Jpn. Pat. Appln. KOKAI Publication No. 9-83712).

In addition, occasionally, a copy job executed by operating a control panel provided at a MFP and a facsimile job executed by remote control operation via a network are started at the same time. In this case, a proposed MFP controls a job to be executed in a preferential manner (Jpn. Pat. Appln. KOKAI Publication Nos. 2004-289480 and 2002-165047).

### BRIEF SUMMARY OF THE INVENTION

According to a first aspect of the present invention, there is provided an image forming apparatus which generates image data from a manuscript and forms an image, the apparatus includes an input unit which inputs a command for operating the image forming apparatus, and a control unit which controls the image forming apparatus by exchanging information with the input unit or an external device, wherein the control unit includes a state establishing unit which establishes a communication connection state for controlling the image forming apparatus by means of an operating command from the external device in response to a connection request from the external device, a state cancel unit which invalidates the control of the image forming apparatus by the operating command from the external device in response to the cancel request from the input unit, and then, switches a current state to a state for controlling the image forming apparatus by means of the operating command from the input unit, and a forcibly terminating unit which forcibly terminates a job being executed in response to the operating command from the external device.

According to a second aspect of the present invention, there is provided an image forming method for use in an image forming apparatus that includes an image forming unit which generates image data from a manuscript and forms an image, an input unit which inputs a command for operating the image forming apparatus, and a control unit which controls the image forming apparatus by exchanging information with the input unit or an external device, the method includes establishing a communication connection state for controlling the image forming apparatus by means of an operating command from the external device in response to a connection request from the external device, invalidating the control of the image forming apparatus by the operating command from the external device in response to the cancel request from the input unit, and then, switching a current state to a state for controlling the image forming apparatus by means of the operating command from the input unit, and forcibly terminating a job being executed in response to the operating command from the external device.

According to a third aspect of the present invention, there is provided an image forming apparatus configured to be communication-connectable to an external device, the apparatus includes a reader unit which reads an image of a manuscript, an image forming unit which forms an image based on image data read by the reader unit, an input unit which is provided at the image forming apparatus and commands reading by the reader unit or image forming by the image forming unit to the image forming apparatus, a communication control unit which controls a communication connection between the image forming apparatus and the external device to execute reading by the reader unit or image forming by the image forming unit, based on the command from the external device, a cancel unit which, while executing a reading operation by the reader unit or an image forming operation by the image forming unit based on the command from the external device, commands the image forming apparatus to interrupt or cancel the operation being executed, and an operation control unit which interrupts or cancels the operation being executed based on an interrupting or canceling command from the cancel unit and newly accepts from the input unit a command input for reading by the reader unit or an image forming operation by the image forming unit.

According to a fourth aspect of the present invention, there is provided an image forming apparatus configured to be communication-connectable to an external device, the apparatus includes a communication control unit which forms a communication state between the external device and the image forming apparatus in response to a request from the external device, an operation executing unit which executes reading of a manuscript or an image forming operation based on image data on the read manuscript, an input unit which is provided at the image forming apparatus to input a command for an operation of the image forming apparatus, and an operation control unit which, in a state in which a communication state with the external device has been established, disconnects the communication state with the external device in response to input contents from the input unit, and then, accepts the input contents from the input unit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram depicting an MFP according to a first embodiment of the present invention;

FIG. 2 is an external view showing a control panel provided at the MFP;

FIG. 3 is a view showing a display example of a liquid crystal display unit;

FIG. 4 is a view showing a configuration of modules that control operations of the MFP;

FIG. 5 is a signal flow chart showing an operation between the MFP and an external device;

FIG. 6 is a view showing the display content of a control panel in a “communication connection state”;

FIG. 7 is a signal flow chart showing an operation between the MFP and the external device; and

FIG. 8 is a signal flow chart showing an operation between the MFP and the external device.

### DETAILED DESCRIPTION OF THE INVENTION

### First Embodiment

Now, a first embodiment of the present invention will be described in detail with reference to the accompanying drawings.

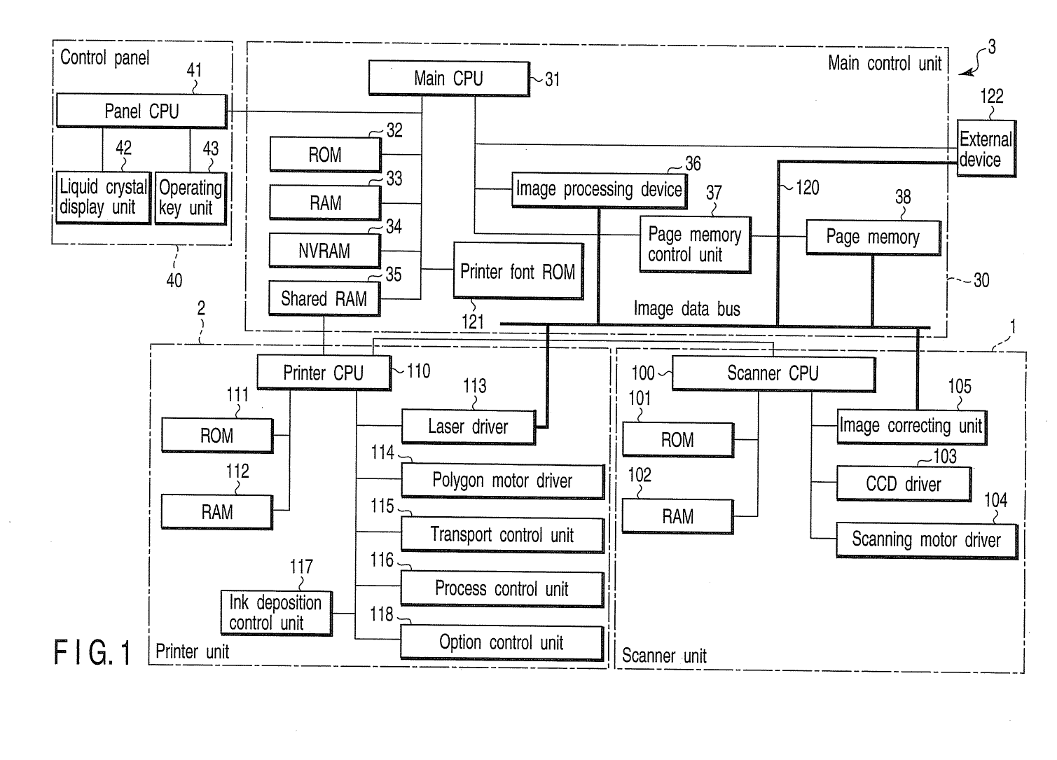

FIG. 1 shows a schematic configuration of a MFP 3 according to the first embodiment of the present invention.

This MFP 3 comprises three central processing units (CPUs), i.e., a main CPU 31 in a main control unit 30; a scanner CPU 100 of a scanner unit 1; and a printer CPU 110 of a printer unit 2.

The main CPU 31 performs bi-directional communication via the printer CPU 110 and a shared random access memory (RAM) 35. The main CPU 31 outputs an operating command, and then, the printer CPU 110 returns a conditional status. The printer CPU 110 and the scanner CPU 100 exchange information in accordance with serial communication. The printer CPU 110 outputs an operating command, and then, the scanner CPU 100 returns a conditional status.

A control panel 40 includes a liquid crystal display unit 42 having a touch panel, a variety of operating key units 43, and a panel CPU 41 connected to these units. Then, the panel CPU 41 is connected to the main CPU 31 to exchange information.

The main control unit 30 includes a main CPU 31, a read only memory (ROM) 32, a RAM 33, a nonvolatile RAM (NVRAM) 34, a shared RAM 35, an image processing device 36, a page memory control unit 37, a page memory 38, and a printer font ROM 121.

The main CPU 31 integrally controls the MFP 3. The ROM 32 stores a program that controls an operation of the MFP 3. The RAM 33 temporarily stores data.

The NVRAM 34 is a nonvolatile memory backed up in a battery (not shown). Even in the case where power is shut down, the NVRAM 34 holds the stored data.

The shared RAM 35 is used when a bi-directional communication is made between the main CPU 31 and the printer CPU 110.

The page memory control unit 37 controls readout and storage of image information with respect to the page memory 38. The page memory 38 has a region capable of storing image information for a plurality of pages and can store data produced by compressing the image information from the scanner unit 1 on a page by page basis.

Font data corresponding to print data is stored in the printer font ROM 121.

The scanner unit 1 includes a scanner CPU 100, a ROM 101, a RAM 102, a CCD driver 103, a scanning motor driver 104, and an image correction unit 105.

The scanner CPU 100 integrally controls the scanner unit 1. The ROM 101 stores a control program or the like. The RAM 102 stores data. The CCD driver 103 drives a color image sensor. The scanning motor driver 104 controls rotation of a scanning motor.

The printer unit 2 includes a printer CPU 110, a ROM 111, a RAM 112, a laser driver 113, a polygon motor driver 114, a transport control unit 115, a process control unit 116, an ink deposition control unit 117, and an option control unit 118.

The printer CPU 110 integrally controls the printer unit 2. The ROM 111 stores a control program or the like. The RAM 112 stores data. The laser driver 113 drives a semiconductor laser oscillator. The polygon motor driver 114 drives a polygon motor of an exposure device. The transport control unit 115 controls transport of paper by means of a transport mechanism. The process control unit 116 controls processes for carrying out electrification, developing, and transfer. The ink deposition control unit 117 controls an ink deposition device. The option control unit 118 controls an option.

The image processing device 36, the page memory 38, the image correction unit 105, and the laser driver 113 are connected to each other by means of an image data bus 120. Further, the image data bus 120 is connected to an external device 122 such as a personal computer.

In addition, the main CPU 31 of this MFP 3 is connected to the external device 122 such as a personal computer.

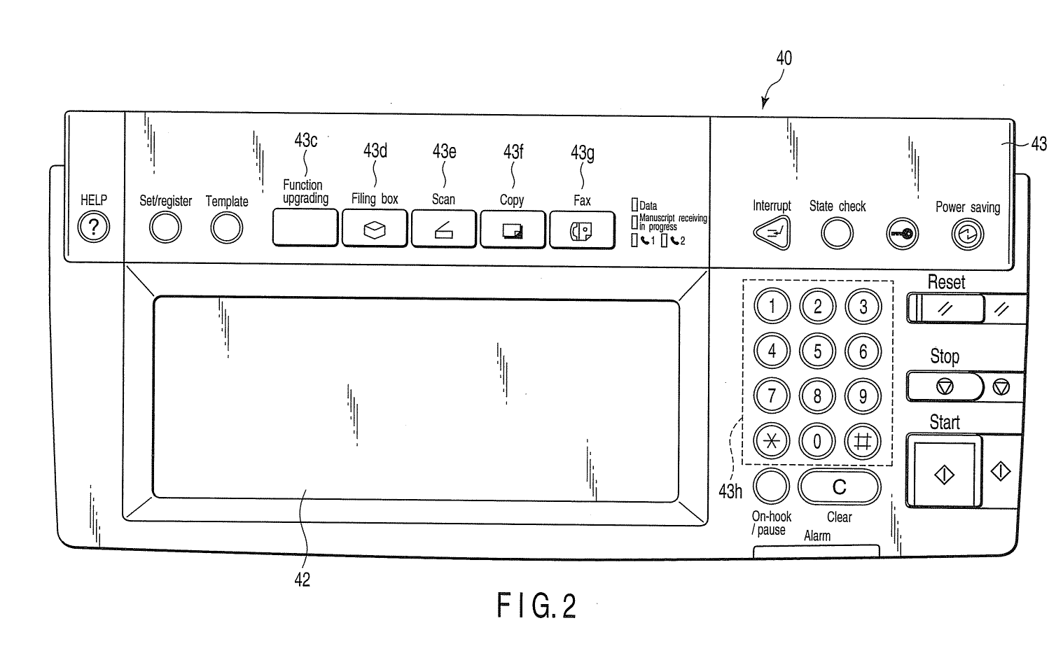

FIG. 2 is an external view showing a control panel 40 provided at the MFP 3. A configuration of a panel face of the control panel 40 will be described with reference to FIG. 2.

A liquid crystal display unit 42 and an operating key unit 43 are provided on the control panel 40.

The state of the MFP 3, operating procedures, and a variety of commands assigned to a user or the like are displayed at the liquid crystal display unit 42. In addition, a touch panel is provided at the liquid crystal display unit 42 so that a user can assign a variety of commands to the MFP 3.

A variety of operating buttons for operating the MFP 3 are provided at the operating key unit 43. A function upgrading (extension) button 43c, a filing box button 43d, a scan button 43e, a copy button 43f, a fax button 43g and the like are allocated as keys for calling a screen for selecting and setting a function. In addition, numeric keys 43h or the like for inputting set values and checking information are also allocated.

The extension button 43c is used when a function is upgraded in the future. The filing box button 43d is used when stored image data is fetched. The scan button 43e is used when a scan function is used. The copy button 43f is used when a copy function is used. The fax button 43g is used when a fax function is used. Ten numeric keys 43h are used when numbers are inputted.

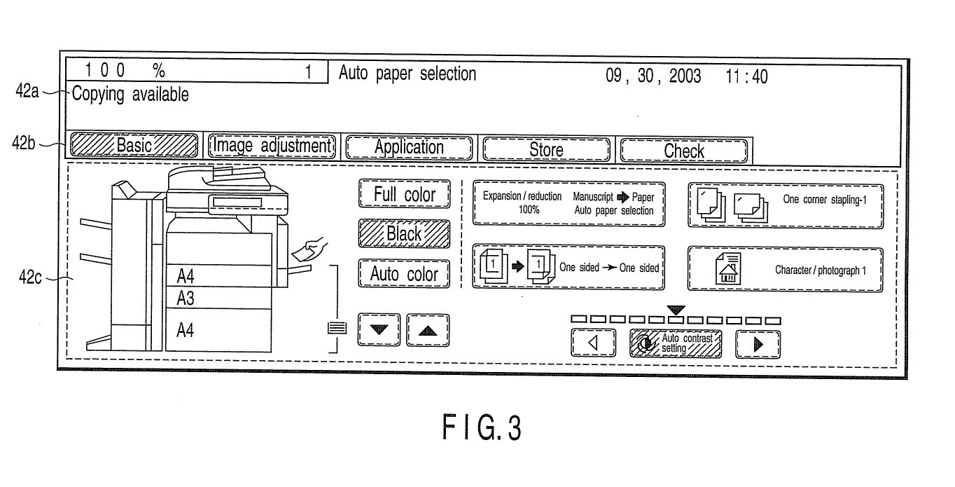

FIG. 3 is a view showing a display example of the liquid crystal display unit 42. At this liquid crystal display unit 42, a function set at that time point, a selected function, a state of an MFP 3 or the like are displayed by way of message or illustration.

The liquid crystal display unit 42 includes a message display area 42a, an index button area 42b, and a function setting button area 42c.

In the message display area 42a, there are displayed: information such as a magnification, the number of copies, a cassette paper size, date and time or the like together with messages such as a machine state, an operating command, and caution. The index button area 42b is equipped with an index button for switching a menu. The type or number of index buttons are different depending on copy, scan, and fax functions. The function setting button area 42c is an area in which to select and set a variety of functions.

Now, an operation of the MFP 3 will be described here.

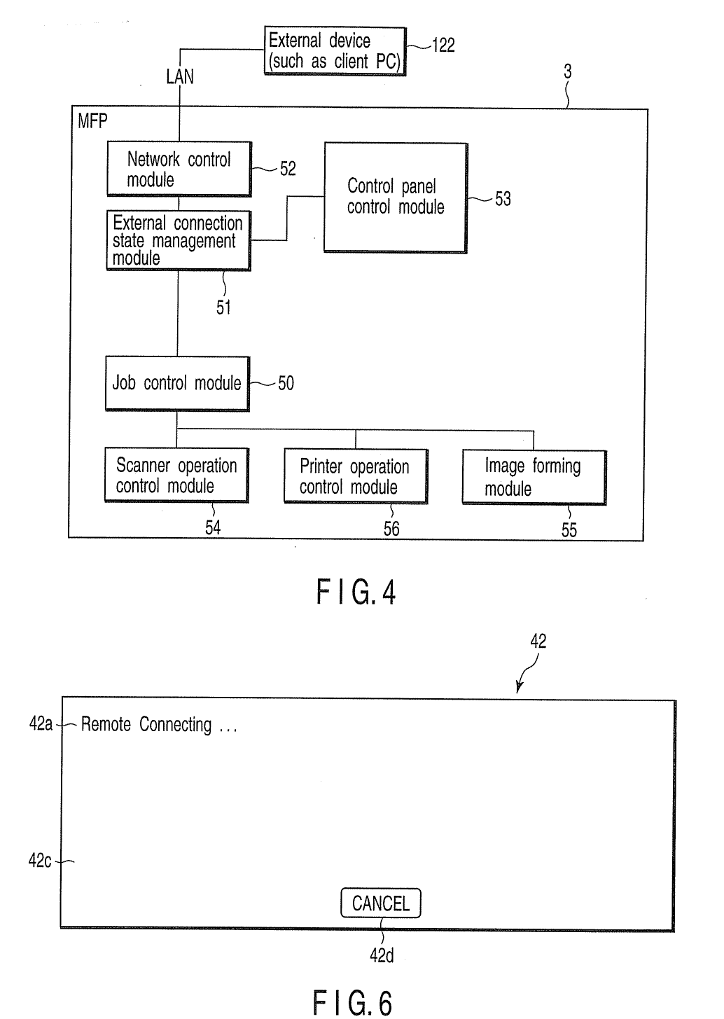

FIG. 4 is a view showing a configuration of modules that control the operation of the MFP 3.

The MFP 3 is equipped with a job management module 50, an external connection state management module 51, a network control module 52, a control panel control module 53, a scanner operation control module 54, an image forming module 55, and a printer operation control module 56.

The job management module 50 manages an operation of a job executed by the MFP 3. The external connection state management module 51 checks whether or not connection between the external device 122 and the control panel 40 is normal. The network control module 52 is an interface that controls exchange of information between the external device 122 and the MFP 3.

The control panel control module 53 receives operating/command information and controls an operation of the control panel 40 that displays a message. The scanner operation control module 54 controls an operation of the scanner unit 1 that reads an image of a manuscript and then generates image data. The image forming module 55 controls an image forming operation of applying processing to the read image data to form an image for printing. The printer operation control module 56 controls an operation of the printer unit 2 that records a formed image in a medium.

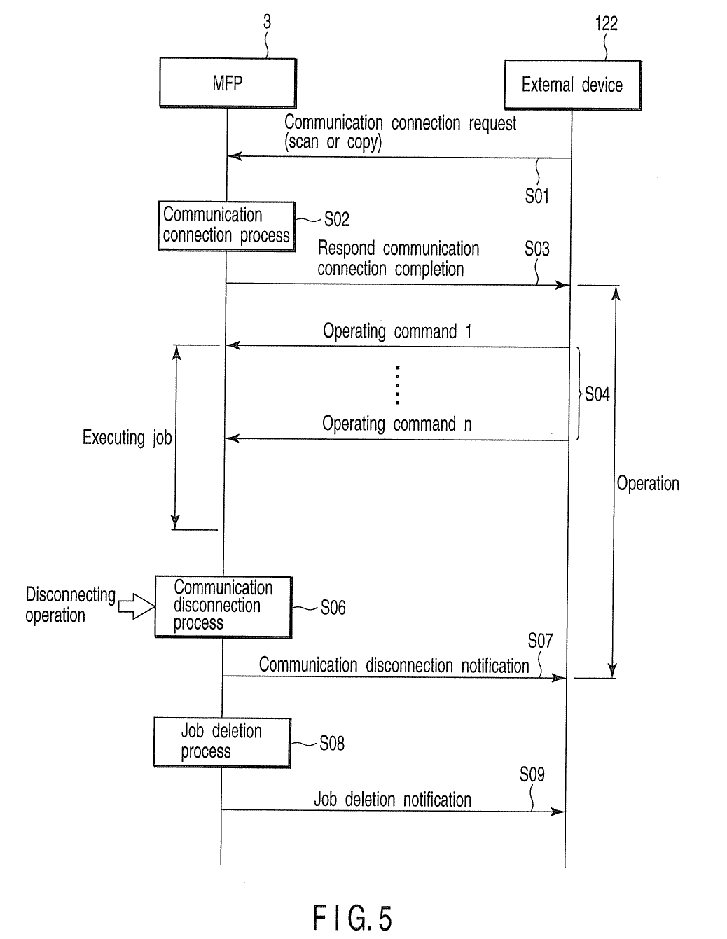

FIG. 5 is a signal flow chart showing an operation between the MFP 3 and the external device 122. The operation of the MFP 3 described below is achieved by the control modules shown in FIG. 4 being loaded on the CPUs 31, 41, 100, and 110, and then, cooperating with each unit of the MFP 3.

In a client personal computer (PC) serving as the external device 122, for example, a user starts up driver software for operating the MFP 3. Then, in step S01, the external device 122 transmits a communication connection request to the MFP 3.

This communication connection request is made while a job is specified for the MFP 3. This job includes a remote scan, a remote copy and the like. When the remote scan is specified, the MFP 3 is operated via a network so that a manuscript can be read and stored. When the remote copy is specified, the MFP 3 is operated via a network so that a manuscript can be read and printed.

In the MFP 3, upon receiving the communication connection request, as long as the MFP 3 is not executing a job, the main CPU 31 executes a communication connection process in step S02. In the communication connection process, for example, a flag is set in a predetermined area of the RAM 33, and then, a predetermined display or the like is made on the control panel 40. In accordance with this communication connection process, the current state moves to a state in which the MFP 3 operates in accordance with an operation from the external device 122. This state is called a “communication connection state” in the following description.

After completing the communication connection process, in step S03, the main CPU 31 returns to the external device 122 a response indicating that the “communication connection state” has been established.

In the external device 122 having received this response, an operation with respect to the MFP 3 is enabled. The operating contents include, for example, modification of a variety of parameters in a scan job, an operation start command or the like. In step S04, operating commands 1, . . . , n are transmitted to the MFP 3 in response to an operation at the external device 122. In the MFP 3, jobs corresponding to the transmitted operating commands 1, . . . , n are executed.

FIG. 6 is a view showing the display content of the liquid crystal display unit 42 in the “communication connection state”. The fact that the “communication connection state” with the external device 122 is established is displayed on the liquid crystal display unit 42. Therefore, in this state, a user cannot make an operational input from the control panel 40.

On the other than, a cancel key 42d is displayed at the liquid crystal display unit 42. This cancel key 42d is a key for canceling the “communication connection state”. The user can operate the MFP 3 from the control panel 40 by operating the cancel key 42d.

While, in the present embodiment, a specific screen indicating that the “communication connection state” is established has been provided, the fact that the above described “communication connection state” is established and the cancel key may be displayed on a screen of the generally displayed control panel 40, whereby a user operation may be disabled. In addition, in step S01, when a connection request has been received from the external device 122, this fact may be displayed on the control panel 40.

When the user operates the cancel key 42d from the control panel 40, the main CPU 31 execute a communication disconnection process in step S06. In this communication disconnection process, for example, a flag in a predetermined area of the RAM 33 is reset, thereby enabling an operation from the control panel 40.

After the communication disconnection process has been executed, the main CPU 31 notifies the external device 122 that the “communication connection state” has been cancelled in step S07. In the external device 122 having received this notification, an operable state relevant to the MFP 3 is terminated. For example, a warning message is displayed on a display device, although is not shown, of the external device 122. Even after the “communication connection state” has been cancelled, a function of executing communication between the MFP 3 and the external device 122 is effective.

Subsequently, in the MFP 3, in step S08, the main CPU 31 executes a job deletion process. This job deletion process is a process for quickly terminating a job being executed, and immediately delivering an operating privilege to the MFP 3. For example, in the case where a scan job is being executed, manuscript reading is stopped, and an operation of storing a scanned image is canceled. In addition, all of the files stored in the page memory 38 are also deleted. In the case where a copy job is being executed, manuscript reading is stopped, and then, data being currently read is deleted. However, in the case where an image is being printed, a print operation for that image is continued.

Then, after terminating the job deletion process, the main CPU 31 enables an operation from the control panel 40. In addition, in step S09, this main CPU notifies the external device 122 of the fact that the job deletion has been made. In the external device 122 having received this notification, for example, a message indicating that a requested job has been deleted is displayed on a display device, although not shown.

According to the present embodiment, even if a remote job is being executed, a user can start a direct operation from the control panel 40 immediately.

### Second Embodiment

A second embodiment is different from the first embodiment in that a job termination process is executed instead of the job deletion process. Therefore, like constituent elements in the first embodiment are designated by like reference numerals. A detailed description thereof is omitted here.

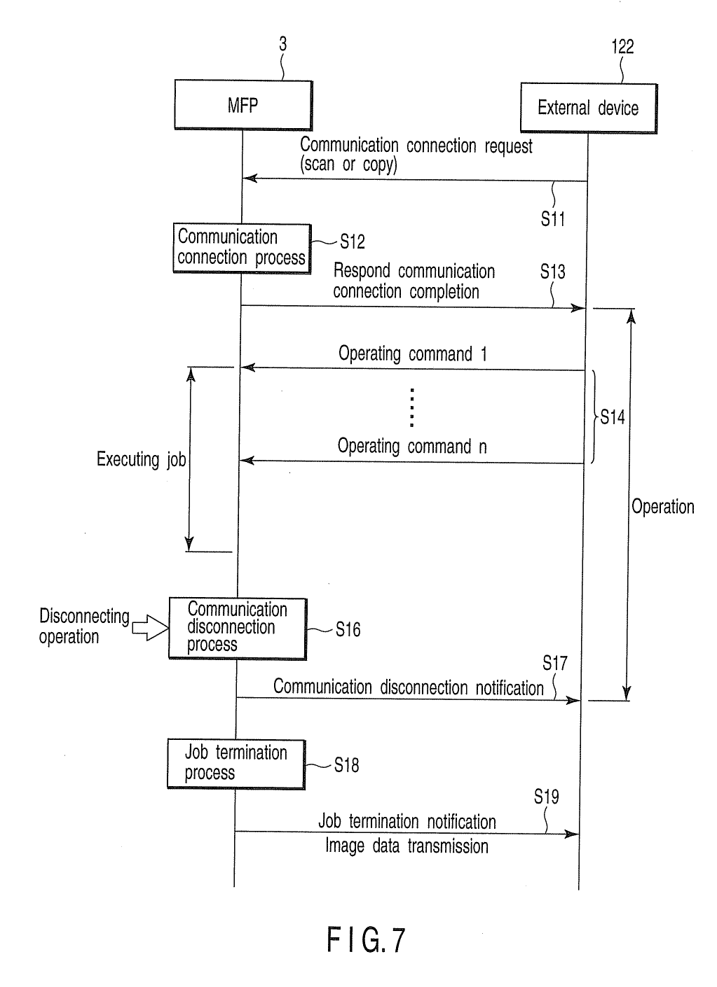

FIG. 7 is a signal flow chart showing an operation between an MFP 3 and an external device 122. In FIG. 7, operations from step S11 to step S17 are identical to those according to the first embodiment. Thus, a duplicate description thereof is omitted here.

In step S18, in the MFP 3, a main CPU 31 executes a job termination process. This job termination process is a process for delivering an operational privilege to the MFP 3 after storing a result of a job being executed, unlike the job deletion process described above.

For example, in the case where a scan job is being executed, manuscript reading is stopped, whereas an operation of storing a scanned image is continued. A file stored in a page memory 38 is not deleted, either. In the case where a copy job is being executed, manuscript reading is stopped, and printing of currently read data is continued.

Then, after executing the job termination process, the main CPU 31 enables an operation from a control panel 40. In addition, in step S19, this main CPU notifies the external device 122 that the job has been terminated. Further, the main CPU 31 transmits to the external device 122 the image data stored in the page memory 38.

The external device 122 displays on a display device, although not shown, for example, a message indicating that a requested job has been forcibly terminated. Further, a message indicating that the read image data has been received is also displayed. Then, in the external device 122, a received image can be displayed and can also be transmitted to another device while the image is attached to an E-mail.

According to the present embodiment, while supporting execution of a remote job, a user can start a direct operation from the control panel 40 immediately.

### Third Embodiment

A third embodiment is different from the second embodiment in that a communication disconnection operation is enabled from an external device 122. Therefore, like constituent elements in the second embodiment are designated by like reference numerals. A detailed description thereof is omitted here.

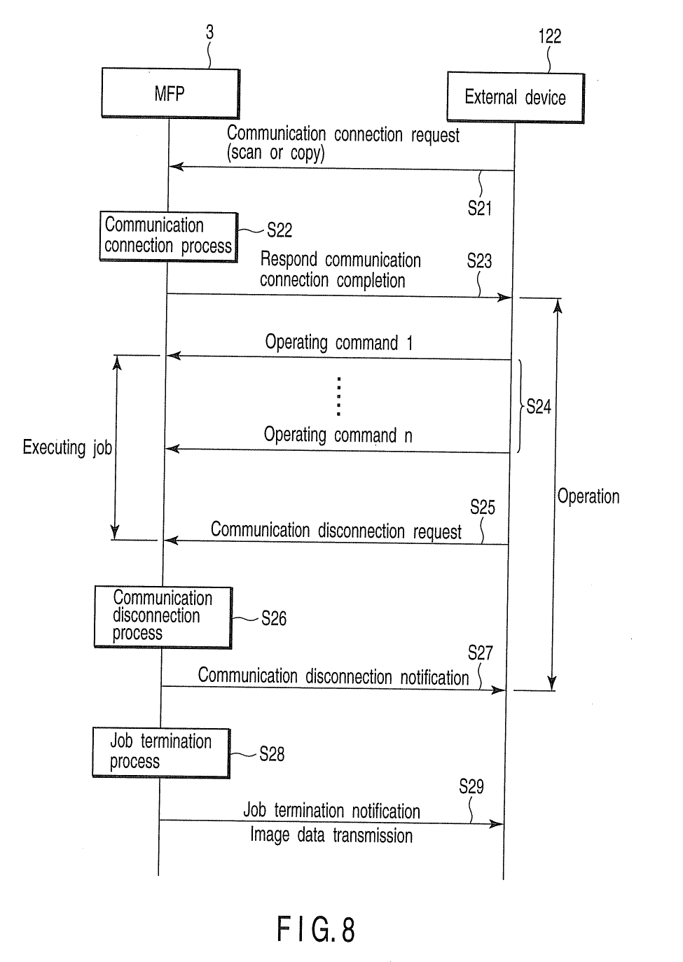

FIG. 8 is a signal flow chart showing an operation between an MFP 3 and an external device 122. In FIG. 8, operations from step S21 to step S24 are identical to those according to the second embodiment. Thus a duplicate description thereof is omitted here.

In the external device 122, there is a case in which an attempt is made to cancel an operation of the MFP 3. For example, this case corresponds to a case where an attempt is made to carry out another job in the external device 122, or alternatively, a case in which an attempt is made to cancel an operation because an operation time has been longer than a predetermined limit.

When a user operates the external device 122, and then, inputs a communication disconnection, a communication disconnection request is transmitted to the MFP 3 in step S25.

A main CPU 31 having received this communication disconnection request executes a communication disconnection process in step S26. In this communication disconnection process, for example, a flag in a predetermined area of a RAM 33 is reset, thereby enabling an operation from a control panel 40.

After executing the communication disconnection process, the main CPU 31 notifies the external device 122 that the “communication connection state” has been cancelled in step S27. In the external device 122 having received this notification, an operable state relevant to the MFP 3 is terminated. For example, a message indicating that a communication state has been cancelled is displayed on a display device, although not shown.

In step S28, in the MFP 3, the main CPU 31 executes a job termination process. This job termination process has been already described, and thus, a duplicate description is omitted here.

Then, after executing the job termination process, the main CPU 31 enables an operation from the control panel 40. In addition, in step S29, this main CPU notifies the external device 122 that a job has been terminated. Further, the main CPU 31 transmits to the external device 122 the image data stored in a page memory 38.

The external device 122 displays on a display device, although not shown, for example, a message indicting that a request job has been terminated. Further, a message indicating that read image data has been received is also displayed. Then, the external device 122 can display a received image and can also transmit it to another device while the image is attached to an E-mail.

According to the present embodiment, the external device 122 can flexibly control execution of a remote job. For example, the remote job can be prevented from being executed for a long period of time. Therefore, a user can start an operation from the control panel 40 smoothly without waiting for long.

As has been described above, according to the foregoing embodiments of the invention, when the MFP is used, even if the MFP is in a “communication connection state” with an external device, the “communication connection state” with the external device is cancelled, thereby making it possible to prioritize a job for directly operating the MFP. That is, even if the MFP is being operated from the external device, the user's operability can be improved without making the user wait in front of the MFP by enabling the “communication connection state” of the external device to be cancelled.

In addition, the MFP according to the foregoing embodiments of the invention is excellent in operability because the “communication connection state” of the MFP with the external device can be cancelled from a control panel of the MFP.

In addition, the MFP according to the foregoing embodiments of the invention can notify the external device that the “communication connection state” with the external device has been cancelled. Therefore, the current operation can be continued smoothly.

In addition, by using a combination of the first and second embodiments described above, a user may select in advance which of the job deletion process and the job termination process is operated from the control panel 40.

The functions described in the foregoing embodiments may be configured using hardware. In addition, a program having described the functions using software may be packaged by causing a computer to read the program. In addition, the functions each may be configured by properly selecting any of the software and the hardware.

Further, the functions each can also be packaged by causing a computer to read a program stored in a recording medium, although not shown. Here, the recording medium in the present embodiment may be formed in any recording format, as long as the medium is capable of recording a program and is computer-readable.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus which generates image data from a manuscript and forms an image, the apparatus comprising:
an input unit which inputs a command for operating the image forming apparatus; and
a control unit which controls the image forming apparatus by exchanging information with the input unit or an external device,
wherein the control unit comprises:
a state establishing unit which establishes a communication connection state for controlling the image forming apparatus by means of an operating command from the external device in response to a connection request from the external device;
a state cancel unit which invalidates the control of the image forming apparatus by the operating command from the external device in response to the cancel request from the input unit, and then, switches a current state to a state for controlling the image forming apparatus by means of the operating command from the input unit; and
a forcibly terminating unit which forcibly terminates a job being executed in response to the operating command from the external device.

2. The image forming apparatus according to claim 1, wherein the forcibly terminating unit alternately includes
a data deleting unit which deletes image data generated by the job after forcibly terminating the job; and
a data storage unit which stores the image data generated by the job after forcibly terminating the job.

3. The image forming apparatus according to claim 2, wherein the data storage unit includes an image transmitting unit which transmits the stored image data to the external device.

4. The image forming apparatus according to claim 3, wherein the input unit enables an operation of selecting which of the data deleting unit and the data storage unit is operated by the forcibly terminating unit.

5. The image forming apparatus according to claim 1, wherein, when the connection request has been made from the external device, the state establishing unit establishes the communication connection state in the case where there exists no job being executed.

6. The image forming apparatus according to claim 5, wherein, in the communication connection state, the input unit displays that the image forming apparatus is in that state and enables only an operation of canceling the communication connection state.

7. An image forming method for use in an image forming apparatus that includes an image forming unit which generates image data from a manuscript and forms an image, an input unit which inputs a command for operating the image forming apparatus, and a control unit which controls the image forming apparatus by exchanging information with the input unit or an external device, the method comprising:
establishing a communication connection state for controlling the image forming apparatus by means of an operating command from the external device in response to a connection request from the external device;
invalidating the control of the image forming apparatus by the operating command from the external device in response to the cancel request from the input unit, and then, switching a current state to a state for controlling the image forming apparatus by means of the operating command from the input unit; and
forcibly terminating a job being executed in response to the operating command from the external device.

8. The image forming method according to claim 7, wherein forcibly terminating the job comprises:
deleting image data generated by the job after forcibly terminating the job; or
storing the image data generated by the job after forcibly terminating the job.

9. The image forming method according to claim 8, wherein storing the data comprises:
transmitting stored image data to the external device.

10. The image forming method according to claim 9, wherein the input unit enables selection as to which of deleting the data and storing the data is executed.

11. The image forming method according to claim 7, wherein in establishing the state, when the connection request has been made from the external device, the communication connection state is established in the case where there does not exist a job being executed.

12. The image forming method according to claim 11, wherein, in the communication connection state, the fact that the image forming apparatus in that state is displayed on the input unit and only an operation of canceling the communication connection state is enabled from the input unit.

13. An image forming apparatus configured to be communication-connectable to an external device, the apparatus comprising:
a reader unit which reads an image of a manuscript;
an image forming unit which forms an image based on image data read by the reader unit;
an input unit which is provided at the image forming apparatus and commands reading by the reader unit or image forming by the image forming unit to the image forming apparatus;
a communication control unit which controls a communication connection between the image forming apparatus and the external device to execute reading by the reader unit or image forming by the image forming unit, based on the command from the external device;
a cancel unit which, while executing a reading operation by the reader unit or an image forming operation by the image forming unit based on the command from the external device, commands the image forming apparatus to interrupt or cancel the operation being executed; and
an operation control unit which interrupts or cancels the operation being executed based on an interrupting or canceling command from the cancel unit and newly accepts from the input unit a command input for reading by the reader unit or an image forming operation by the image forming unit.

14. The image forming apparatus according to claim 13, wherein, while the image forming apparatus is executing reading by the reader unit or image forming by the image forming unit based on a command from the external device, the operation control unit makes control not to accept a command input for reading by the reader unit or an image forming operation by an image forming unit from the input unit.

15. The image forming apparatus according to claim 13, wherein, in the case where the operation being executed has been interrupted or cancelled by the cancel unit, the fact that the operation has been cancelled is notified to the external device.

16. The image forming apparatus according to claim 13, wherein the image forming apparatus generates a reading job or an image forming job, based on a command from the external device or the input unit and deletes a job being executed, based on an input from the cancel unit.

17. The image forming apparatus according to claim 16, wherein, when a job being executed is deleted, read image data is deleted.

18. The image forming apparatus according to claim 16, wherein, when a job being executed is deleted, read image data is transmitted to the external device.

19. The image forming apparatus according to claim 16, wherein, when a job being executed is deleted, image forming is executed based on read image data.

20. An image forming apparatus configured to be communication-connectable to an external device, the apparatus comprising:
a communication control unit which forms a communication state between the external device and the image forming apparatus in response to a request from the external device;
an operation executing unit which executes reading of a manuscript or an image forming operation based on image data on the read manuscript;
an input unit which is provided at the image forming apparatus to input a command for an operation of the image forming apparatus; and
an operation control unit which, in a state in which a communication state with the external device has been established, disconnects the communication state with the external device in response to input contents from the input unit, and then, accepts the input contents from the input unit.

21. The image forming apparatus according to claim 20, wherein, the input unit includes a liquid crystal unit and changes display on the liquid crystal unit in accordance with whether the external device and the image forming apparatus are in a communication state or in a non-communication state.
